(19) United States
(12) Patent Application Publication
(10) Pub. No.: US 2026/0230324 A1
(43) Pub. Date: Aug. 6, 2026

(54) METHOD AND SYSTEM FOR GRANTING AND VERIFYING A RIGHT TO USE AN OBJECT THROUGH NON-FUNGIBLE TOKEN AND MACHINE-READABLE MEDIUM

(71) Applicant: Sony Group Corporation, Tokyo (JP)

(72) Inventor: Rik CLAESEN, Stuttgart (DE)

(73) Assignee: Sony Group Corporation, Tokyo (JP)

(21) Appl. No.: 19/151,660

(22) PCT Filed: Mar. 1, 2024
(86) PCT No.: PCT/EP2024/055407

§ 371 Date: Jul. 29, 2025

(30) Foreign Application Priority Data
Mar. 10, 2023 (EP) 23161122.9

(51) Int. Cl. H04L 9/32; H04L 9/08; H04L 9/30

(52) U.S. Cl. CPC H04L 9/3213; H04L 9/0825; H04L 9/30; H04L 2209/56

(57) ABSTRACT

A method and system for granting and verifying a right to use an object through non-fungible token (NFT). An NFT associated with the object. the object is created and a cryptocurrency wallet is set up for the object. When a right to use the object is granted to a user, an NFT associated with the object is transferred from a first cryptocurrency address to a second cryptocurrency address in a cryptocurrency wallet, and a public key associated with the second cryptocurrency address is transferred to the user. The right to use the object can be verified based on the public key associated with the second cryptocurrency address.

### FIELD

Examples relate to a method and system for granting and verifying a temporary right to use an object through non-fungible token (NFT).

### BACKGROUND

Conventionally, renting a vehicle (e.g., a car) is normally done as follows: 1) go to a renting company and register, 2) make a vehicle reservation, 3) use a credit card or other payment methods to provide for a guarantee, 4) receive a vehicle key and operate a vehicle, and 5) return the vehicle and the vehicle key after the use. With developments of new technologies, the vehicle renting can be done as follows: 1) register online with a renting company, 2) make an online car reservation, 3) transfer some crypto currencies to an address to deposit a guarantee, 4) receive a digital unlock/start code or a new/reused token that allows an access to the car, and 5) reset the unlock/start code or destroy the token on return of the vehicle.

With the new technologies, users do not have to worry about safe return of the car key anymore. However, there are still some important issues left. A new unlock/start code or a new access token needs to be created for each vehicle renting event, and on return, the unlock/start code needs to be reset or the token needs to be destroyed.

NFTs may be used as a token to prove temporary ownership of the vehicle. When a car renter receives an NFT in his/her cryptocurrency wallet, the car renter could easily prove to the car lock/start mechanism that he/she is the owner of the rental NFT token. The main problem here is that if the car renter does not send the NFT token back to the car rental company, the car rental company has a problem. Depositing a bigger collateral for return of the NFT token could solve this problem in some cases but potential problems may arise when this rental NFT, that is not returned, can still be used.

This issue becomes even more complex for car sharing. People that share a same car typically use an app to make their car reservation. There would be issues with respect to preventing somebody from the allowed pool of users from using the car while it was reserved for somebody else, generating new access codes for each reservation, and cancelling the old access codes, etc.

Therefore, there is a need for a solution that requires no new unlock/start code or access token generation for each rental event and guarantees that the renter cannot access/use the rental vehicle anymore once the rental vehicle is returned or when the rental/use period has expired.

### SUMMARY

In accordance with one example, a method and system for granting a right to use an object through NFT is disclosed. An NFT that represents the ownership of an object (e.g., a vehicle, etc.) is created. The object has a capability of accessing its own cryptocurrency wallet that can hold and move around an NFT. When a user (e.g., a renter of a vehicle) rents or reserves a right to use the object, the NFT associated with the object is transferred from an initial cryptocurrency address to a new cryptocurrency address in the cryptocurrency wallet. The public key associated with the new cryptocurrency address in the cryptocurrency wallet is used as an access/unlock/start code for the object by the user. When the user returns the object or when the reservation period has expired, the NFT is moved to a cryptocurrency wallet address that conceptually serves as a waiting address. When a next person rents or reserves the object, the NFT is then transferred to another cryptocurrency address in the cryptocurrency wallet.

In accordance with another example, a method and system for verifying a right to use an object through NFT is disclosed. When a right to use the object is granted to a user, an NFT associated with the object is transferred from a first cryptocurrency address to a second cryptocurrency address in the cryptocurrency wallet that was set up for the object. The user receives a public key associated with the second cryptocurrency address from the owner and presents the public key to the object to access, unlock, and/or start the object. When the user presents the public key to the system running in the object, the system accesses a cryptocurrency wallet set up for the object and verifies whether the user has a right to use the object based on the public key presented by the user. For example, the system may verify whether the user has a right to use the object by checking whether the cryptocurrency wallet includes an NFT associated with the object at a cryptocurrency address derived from the public key. If the verification is successful, the user can access to, unlock, and/or start the object. If the verification is not successful, access to the object is rejected.

### BRIEF DESCRIPTION OF THE FIGURES

Some examples of apparatuses and/or methods will be described in the following by way of example only, and with reference to the accompanying figures, in which:

FIG. 1 shows an example of a Details section of an NFT item in an NFT marketplace;

FIG. 2 is a flow diagram of an example process for granting a temporary right to use an object in accordance with one example;

FIG. 3 shows an example hierarchical deterministic tree (HDT);

FIG. 4 shows derivation of a public key from a private key and derivation of a cryptocurrency address from the public key;

FIG. 5 shows an example scenario for renting a vehicle using NFT;

FIG. 6 is a flow diagram of an example process for verifying a right to use an object;

FIG. 7 is an example system for granting a right to use an object; and

FIG. 8 is an example system for verifying a right to use an object.

### DETAILED DESCRIPTION

Various examples will now be described more fully with reference to the accompanying drawings in which some examples are illustrated. In the figures, the thicknesses of lines, layers and/or regions may be exaggerated for clarity.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e., only A, only B as well as A and B. An alternative wording for the same combinations is “at least one of A and B”. The same applies for combinations of more than 2 elements.

The terminology used herein for the purpose of describing particular examples is not intended to be limiting for further examples. Whenever a singular form such as “a,” “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises,” “comprising,” “includes” and/or “including,” when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong.

Examples for granting and verifying a temporary right to use an object through NFT will be explained hereafter. The examples will be explained with reference to renting a vehicle such as a car (i.e., granting a temporary right to access/use a vehicle and verifying the right to access/use the vehicle). It should be noted that the examples disclosed herein are not limited to renting a vehicle, but applicable to renting for any objects, such as motorcycle, (e)bike, (e)scooter, or electronic devices such as laptops or smart phones, etc. The examples are also applicable to other scenarios other than renting, such as leasing or time-sharing of an object, or the like.

In examples, a temporary right to use an object is granted and verified through NFT. An NFT is a unique digital identifier that is recorded in a blockchain (e.g., Ethereum, etc.). An NFT can be used to certify authenticity and ownership of an object. The ownership of an NFT is recorded in the blockchain and can be transferred by the owner. An NFT can have only one owner at a time. Ownership of an NFT is managed through a unique identifier and metadata that no other tokens can replicate. NFTs are minted through smart contracts that assign ownership and manage the transferability of the NFTs. When someone creates or mints an NFT, they execute a code stored in smart contracts that conform to a standard, such as ERC-721. This information is added to the blockchain where the NFT is being managed. The NFT minting process, from a high level, has the following steps: creating a new block on a blockchain, validating information, and recording the information into the blockchain.

NFTs have some special properties. Each token minted has a unique identifier that is directly linked to one blockchain address (e.g., Ethereum address). NFTs are not directly interchangeable with other NFTs one-to-one. For example, 1 ETH is exactly the same as another ETH. However, this is not the case with NFTs. Each token has an owner, and this information is easily verifiable. NFTs live on a blockchain (e.g., Ethereum) and can be bought and sold on any NFT market (e.g., Ethereum-based NFT market). If someone owns an NFT, the owner can easily prove the ownership. Proving an ownership of an NFT is very similar to proving that he/she has ETH in an account. For example, when someone purchases an NFT, the ownership of the unique token is transferred to the cryptocurrency wallet via the purchaser's public address. The token proves that the copy of the digital file is the original.

NFTs can be stored in a cryptocurrency wallet. When a cryptocurrency wallet is created, a pair of keys (one public key and one private key) are generated. The public key essentially verifies ownership of a particular cryptocurrency wallet, while the private key is used to digitally sign transactions. The cryptocurrency wallet address is derived from the public key through hashing.

Ethereum addresses (as an example of crypt address) are generated as follows. It starts with a public key (64 bytes). A cryptographic hash (e.g., Keccak-256 hash) of the public key is taken, which generates a string of 32 bytes. The last 20 bytes of this public key hash (e.g., Keccak- 256 hash) is taken as the Ethereum address. In other words, the first 12 bytes are dropped. These 20 bytes (or 40 characters) are the Ethereum address. When prefixed with 0x, it becomes 42 characters long.

When an NFT is created for digital content, the content creator's public key serves as a certificate of authenticity for the digital content, and the private key is proof-of-ownership of the original. The creators public key is essentially a permanent part of the token's history. The creator's public key can demonstrate that the token you hold was created by a particular individual, thus contributing to its market value (vs. a counterfeit). Another way to think about proving you own the NFT is by signing messages to prove you own the private key behind the address. As mentioned above, the private key is proof-of-ownership of the original. The private keys behind that address control the NFT. A signed message can be used as proof of ownership of the private key without revealing them to anybody and thus proving the ownership of the NFT as well. When you pay for an NFT, what you get is the right to transfer the token to your cryptocurrency wallet (i.e., digital wallet). The token proves that your copy of a digital file is the original, like owning an original painting. Just as masterpiece paintings can be copied and distributed as inexpensive posters, anyone can have a digital copy of your NFT.

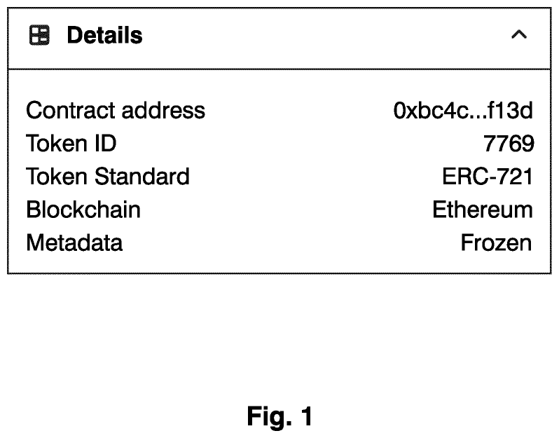

One of the unique benefits of NFTs is the ability to track every transaction on the blockchain. Every NFT has an owner, creator, and history, and this information or “provenance” is verifiable on the blockchain. Each item page of an NFT in an NFT marketplace has a Details section where details about the contract used to create it can be verified. FIG. 1 shows an example of a Details section of an NFT item in an NFT marketplace. “Contract Address” refers to the address where the contract is deployed on the blockchain (e.g., Ethereum). “Token ID” is a code that refers to this specific NFT. “Token Standard” refers to the standard to which the smart contract this NFT conforms. “Blockchain” refers to the blockchain this NFT is on. “Metadata” indicates whether this NFT metadata is centralized or frozen.

In accordance with examples disclosed herein, an object (e.g., a vehicle, etc.) has a capability of accessing its own cryptocurrency wallet that can hold and move around an NFT that represents the ownership of the object. When a user (e.g., a renter of a vehicle) rents or reserves a right to use the object, an NFT associated with the object is transferred from an initial cryptocurrency address to a new cryptocurrency address in the cryptocurrency wallet that was set up for the object. The public key associated with the new cryptocurrency address in the cryptocurrency wallet is then used as an access/unlock/start code for the object by the user. When the user returns the object or when the reservation period has expired, the NFT is moved to a cryptocurrency wallet address that conceptually serves as a waiting address. When a next person rents or reserves the object, the NFT is then transferred to another cryptocurrency address in the cryptocurrency wallet.

An NFT can be passed around from one cryptocurrency address to another. The cryptocurrency address that holds the NFT serves as a unique marker to serve the renting or granting/verifying the right to use the object. The actual owner of the object has access to the cryptocurrency wallet and therefor owns the NFT that represents the object's ownership.

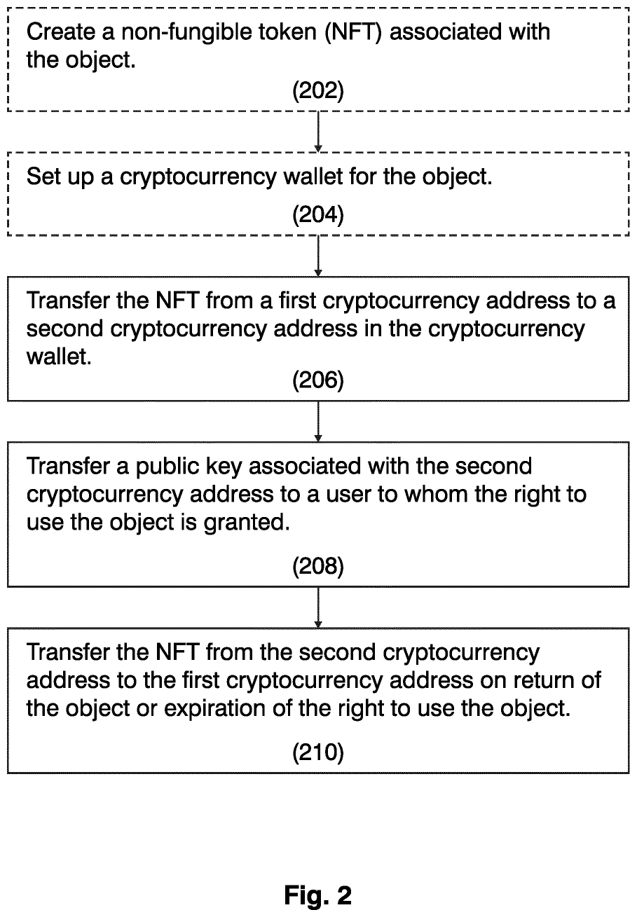

FIG. 2 is a flow diagram of an example process for granting a temporary right to use an object in accordance with one example. An owner of an object or any person who is responsible for managing the object (hereafter “owner”) creates (i.e., mints) an NFT associated with the object (202). NFT minting is a process of writing a digital item to the blockchain (e.g., Ethereum) that supports the NFT. The NFT minting establishes its immutable record of authenticity and ownership. The NFT is created by the owner of the object as a proof of ownership of the object.

The owner also sets up a cryptocurrency wallet (i.e., a digital wallet) for the object (204). The owner may set up a separate cryptocurrency wallet for each object if the owner has multiple objects. The NFT is transferred to a first cryptocurrency address in the object's cryptocurrency wallet. The first cryptocurrency address may serve as a neutral state indicating that the object is currently not reserved or rented out for anyone. The object includes a system that can access its own cryptocurrency wallet. A software module running on the system inside the object can access its own cryptocurrency wallet. The steps 202 and 204 are performed as an initial step for each object before granting a temporary right to use the object.

A user who wants to obtain a temporary right to use the object (e.g., who wants to rent the object) makes a reservation (e.g., online reservation) or any arrangements for using the object, and the owner grants a temporary right to use the object. When the right to use the object is granted to the user, the owner, or alternatively the software module running on the system in the object, transfers the NFT from the first cryptocurrency address to a second cryptocurrency address in the cryptocurrency wallet of the object (206). The second cryptocurrency address may be selected randomly. At this moment, the public key that corresponds with the second cryptocurrency address is still private information for everyone except the holder of the private key.

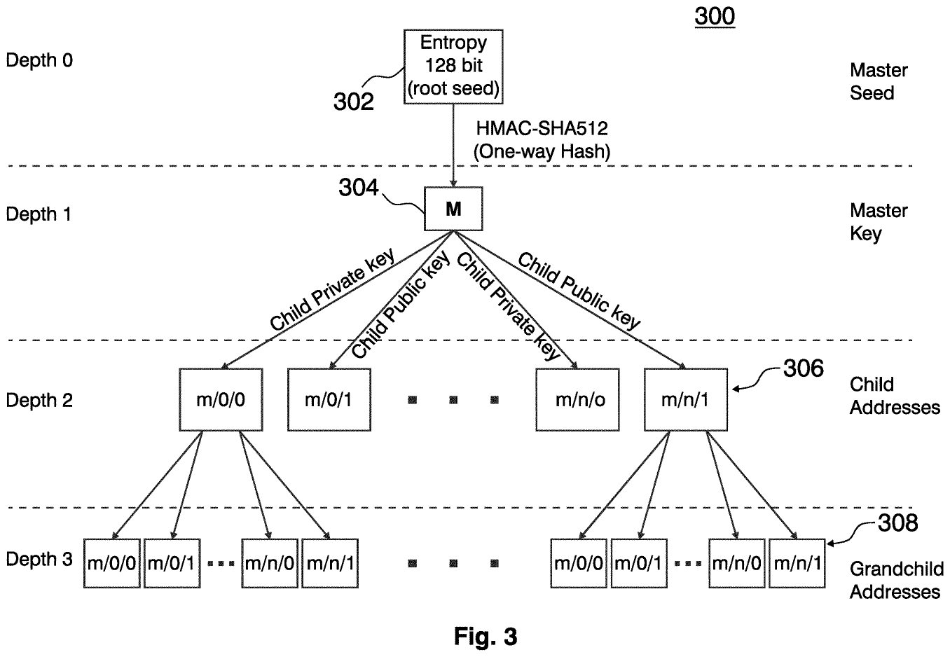

Each cryptocurrency address is associated with a pair of digital keys, i.e., a pair of private and public keys. For example, the digital keys may be created and maintained by a hierarchical deterministic tree (HDT). FIG. 3 shows an example HDT 300. An HDT 300 stores digital keys in a tree structure that is derived from a seed (root seed) 302. The seed 302 generates a master key 304, the master key 304 is used to generate child keys 306, and the child keys 306 are used to generate grandchild keys 308, and so on. The master key 304 may be derived directly from the seed using HMAC-SHA512. An HDT 300 can generate an infinite number of private keys. An HDT 300 is made up of a plurality of “nodes.” Using a child key derivation (CKD) function, many child nodes can be derived from a single parent node. Each node contains three pieces of information: a private key, a public key, and a chain code.

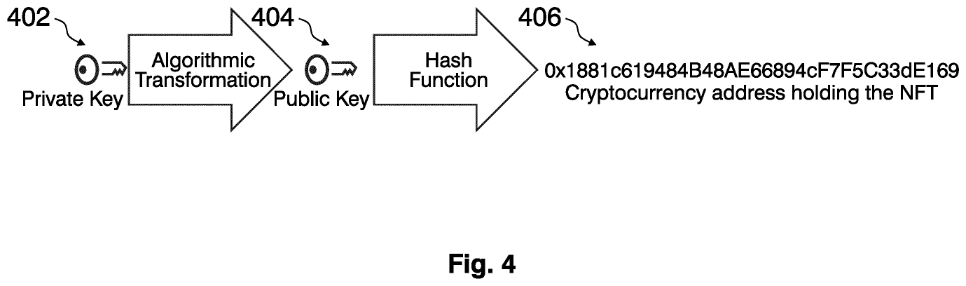

A public key is derived from a private key, and a cryptocurrency address is derived from a public key. FIG. 4 shows derivation of a public key from a private key and derivation of a cryptocurrency address from the public key. A public key 404 is derived from a private key 402 by applying a cryptographic function on the private key 402, and a cryptocurrency address 406 is derived by applying a hashing function on the public key 404.

In the case of a cryptocurrency wallet, the private key is the part that is used to sign transactions and the public key is used to generate the corresponding cryptocurrency address. A different cryptocurrency wallet may be setup for each object by selecting a different seed for each object. The HDT is created by a seed, and the seed is known by the owner of the object and by the software module running on the system inside the object.

Referring again to FIG. 2, the owner then transfers the public key associated with the second cryptocurrency address to the user to whom the right to use the object is granted (208). The right to use the object can be verified based on the public key associated with the first cryptocurrency address. The user who received the public key may access, unlock, and/or start the object using the received public key. The user presents the public key to the software module running on the system in the object to access, unlock, and/or start the object. When the public key is presented to the object, the software module in the object can verify whether the user has a valid right to use the object using the public key. The software module running on the system in the object accesses the cryptocurrency wallet set up for the object and checks if the cryptocurrency address that corresponds to the public key presented by the user holds the NFT. If the verification is successful, the user can proceed (i.e., the object can be accessed, unlocked, and/or started), and if the verification fails, access to the object will be rejected. The public keys that were handed out previously will not work anymore because their corresponding cryptocurrency addresses do not hold the NFT anymore.

When the right to use the object becomes invalid (e.g., if the renting period expires or the object is returned), the owner of the object, or alternatively the software module running on the system in the object, transfers the NFT from the second cryptocurrency address to the first cryptocurrency address (i.e., the cryptocurrency address that serves as a neutral state) (210). At this point no previously valid public key, except the one owned by the owner and that corresponds with the cryptocurrency address that serves as “neutral” state, can access, unlock, and/or start the object.

With this scheme, a right to use the object can be easily granted, revoked, and verified since anyone trying to access, unlock, or start the object by providing a public key that corresponds with a cryptocurrency address not holding the object's NFT will fail. The public key that corresponds with the cryptocurrency address that holds the NFT is private information and is not known to anyone except the owner of the private key for this cryptocurrency address. When the NFT is transferred to a new cryptocurrency address, the public key of the previous cryptocurrency address becomes known as part of the transaction information on the blockchain. However, when this happens, a new user/renter has already received a new unlock/start key (i.e., a new cryptocurrency address public key) which is not known to anybody except the owner of the object.

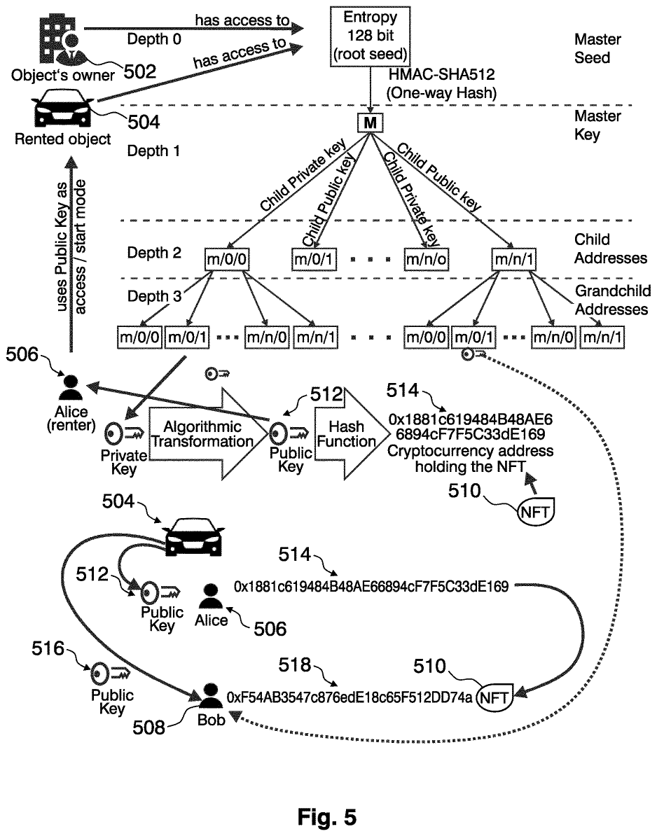

FIG. 5 shows an example scenario for renting a vehicle using NFT. The owner 502 of the vehicle 504 and the system residing in the vehicle 504 can access the cryptocurrency wallet associated with the vehicle 504. When the vehicle 504 is rented to Alice 506, the NFT 510 for the vehicle 504 is transferred to a cryptocurrency address 514 in the cryptocurrency wallet and the corresponding public key 512 is given to Alice 506. Alice 506 can then use the public key 512 to access and start the vehicle 504. When the public key 512 is presented by Alice 506 to the system running in the vehicle, the vehicle 504 (the system running inside the vehicle) then accesses the cryptocurrency wallet associated with the vehicle 504 and verifies whether Alice 506 has a right to use the vehicle 504 by checking whether the cryptocurrency address associated with the public address 512 presented by Alice holds the NFT 510. When the vehicle 504 is subsequently rented to Bob 508, the NFT 510 is transferred to another cryptocurrency address 518 in the cryptocurrency wallet and a corresponding public key 516 is given to Bob 508 to enable Bob 508 to access and start the vehicle 504. At this moment, the public key that were given to Alice 506 will not work since the cryptocurrency address associated with the public key given to Alice 506 no longer holds the NFT.

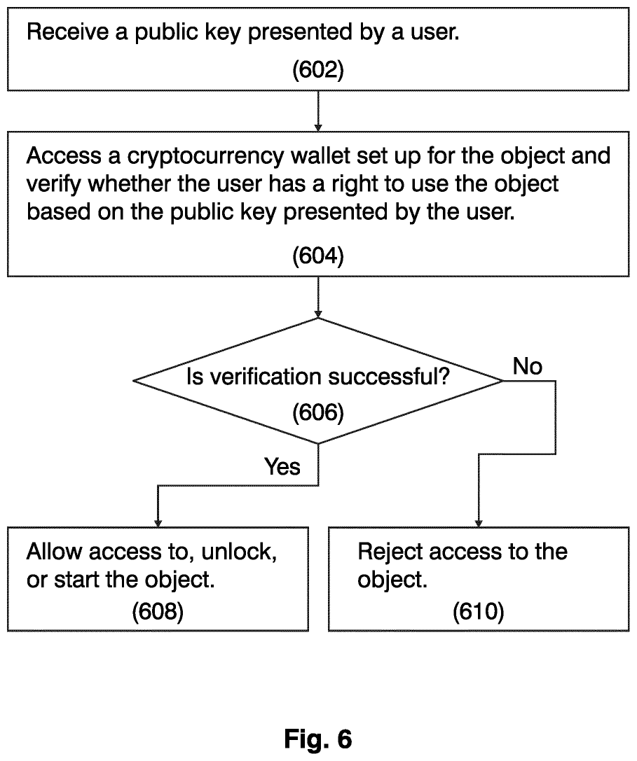

FIG. 6 is a flow diagram of an example process for verifying a right to use an object. A user who wants to use an object makes an arrangement with the owner of the object. On a condition that a right to use the object is granted to a user, the owner, or alternatively the system running inside the object, transfers an NFT associated with the object from a first cryptocurrency address to a second cryptocurrency address in the cryptocurrency wallet that was set up for the object. The user receives a public key associated with the second cryptocurrency address from the owner and presents the public key to the object to access, unlock, and/or start the object.

The system running in the object receives a public key presented by the user (602). The system then accesses a cryptocurrency wallet set up for the object and verifies whether the user has a right to use the object based on the public key presented by the user (604). For example, the system may verify whether the user has a right to use the object by checking whether the cryptocurrency wallet includes an NFT associated with the object at a cryptocurrency address derived from the public key.

If the verification is successful (606), the system allows access to (unlocks, or starts) the object (608). If the verification is not successful (606), the access to the vehicle is rejected (610). The system or the owner may transfer the NFT from the second cryptocurrency address to the first cryptocurrency address in the cryptocurrency wallet on return of the object or expiration of the right to use the object.

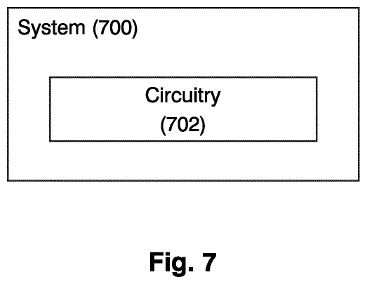

FIG. 7 is an example system 700 for granting a right to use an object. The system includes a circuitry 702 (e.g., a processor, interfacing circuitry, a memory, etc.). The circuitry 702 may be a single device or multiple devices. A user who wants to use an object makes an arrangement with the owner of the object. The circuitry 702 (e.g., a software module running on the circuitry 702) can access the cryptocurrency wallet associated with the object. The circuitry 702 is configured to transfer an NFT associated with the object from a first cryptocurrency address to a second cryptocurrency address in the cryptocurrency wallet for the object on a condition that a right to use the object is granted to a user. The first cryptocurrency address may serve as a neutral state indicating that the object is currently not reserved or rented out for anyone. Each cryptocurrency address is associated with a pair of digital keys: a private key and a public key. The circuitry 702 is configured to transfer a public key associated with the second cryptocurrency address to the user. The right to use the object can be verified based on the public key associated with the second cryptocurrency address.

The circuitry 702 may be further configured to transfer the NFT from the second cryptocurrency address to the first cryptocurrency address in the cryptocurrency wallet on return of the object or expiration of the right to use the object. In some examples, the circuitry 702 may be configured to receive a payment from the user on the second cryptocurrency address.

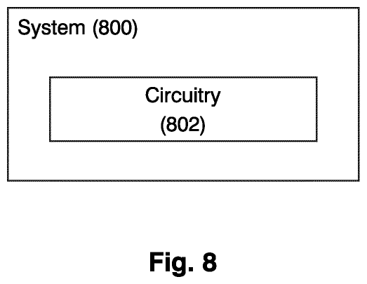

FIG. 8 is an example system 800 for verifying a right to use an object. The system 800 may be included in the object. The system 800 includes a circuitry 802 (e.g., a processor, interfacing circuitry, a memory, etc.). The circuitry 802 may be a single device or multiple devices. A user who wants to use an object makes an arrangement with the owner of the object. On a condition that a right to use the object is granted to a user, the owner, or alternatively the system 800 running inside the object, transfers an NFT associated with the object from a first cryptocurrency address to a second cryptocurrency address in the cryptocurrency wallet set up for the object. The user receives a public key associated with the second cryptocurrency address from the owner and uses the public key to access, unlock, and/or start the object.

The circuitry 802 (e.g., a software module running on the circuitry 802) receives a public key presented by the user. The circuitry 802 is configured to access a cryptocurrency wallet set up for the object and verify whether the user has a right to use the object based on the public key presented by the user. For example, the circuitry 802 may verify whether the user has a right to use the object by checking whether the cryptocurrency wallet includes an NFT associated with the object at a cryptocurrency address derived from the public key presented by the user. The circuitry 802 is configured to allow access to, unlock, and/or start the object if the verification is successful, and reject access to the object if the verification fails. The circuitry 802 may be configured to transfer the NFT from the second cryptocurrency address to the first cryptocurrency address in the cryptocurrency wallet on return of the object or expiration of the right to use the object.

Another example is a computer program having a program code for performing at least one of the methods described herein, when the computer program is executed on a computer, a processor, or a programmable hardware component. Another example is a machine-readable storage including machine readable instructions, when executed, to implement a method or realize an apparatus as described herein. A further example is a machine-readable medium including code, when executed, to cause a machine to perform any of the methods described herein.

The following examples pertain to further embodiments:
(1) A method for granting a right to use an object through non-fungible token, NFT, comprising:
   transferring an NFT associated with the object from a first cryptocurrency address to a second cryptocurrency address in a cryptocurrency wallet set up for the object; and
   transferring a public key associated with the second cryptocurrency address to a user to whom the right to use the object is granted,
   wherein the right to use the object can be verified based on the public key associated with the second cryptocurrency address.
(2) The method of (1), further comprising:
   transferring the NFT from the second cryptocurrency address to the first cryptocurrency address in the cryptocurrency wallet on return of the object or expiration of the right to use the object.
(3) The method of (1) or (2), further comprising:
   receiving a payment from the user on the second cryptocurrency address.
(4) The method of any one of (1)-(3), wherein each cryptocurrency address in the cryptocurrency wallet is associated with a pair of private and public keys, the object is associated to a specific root seed, and private keys associated with the object are generated by a hierarchical deterministic tree (HDT) using the root seed.
(5) The method of any one of (1)-(4), wherein the object includes the cryptocurrency wallet and a software module running on a system in the object verifies the right to use the object by checking whether the second cryptocurrency address in the cryptocurrency wallet includes the NFT.
(6) The method of any one of (1)-(5), wherein the public key is used as an access code to unlock the object.
(7) The method of any one of (1)-(6), wherein the object is a rental vehicle or a shared vehicle shared among a plurality of users.
(8) A method for verifying a right to use an object through non-fungible token, NFT, comprising:
   receiving a public key presented by a user;
   accessing a cryptocurrency wallet set up for the object, wherein an NFT associated with the object is included in the cryptocurrency wallet;
   verifying whether the user has a right to use the object based on the public key; and
   allowing access to the object if the verification is successful, otherwise rejecting access to the object.
(9) The method of (8), further comprising:
   transferring the NFT associated with the object from a first cryptocurrency address to a second cryptocurrency address in the cryptocurrency wallet on a condition that a right to use the object is granted to a user, the second cryptocurrency being derived from the public key; and
   transferring the NFT from the second cryptocurrency address to the first cryptocurrency address in the cryptocurrency wallet on return of the object or expiration of the right to use the object.
(10) A system for granting a right to use an object through non-fungible token, NFT, comprising:
   a circuitry configured to transfer an NFT associated with the object from a first cryptocurrency address to a second cryptocurrency address in a cryptocurrency wallet set up for the object on a condition that a right to use the object is granted to a user; and
   a circuitry configured to transfer a public key associated with the second cryptocurrency address to the user,
   wherein the right to use the object can be verified based on the public key associated with the second cryptocurrency address.
(11) The system of (10), wherein the circuitry is configured to transfer the NFT from the second cryptocurrency address to the first cryptocurrency address in the cryptocurrency wallet on return of the object or expiration of the right to use the object.
(12) The system of any one of (10)-(11), further comprising a circuitry configured to receive a payment from the user on the second cryptocurrency address.
(13) A system for verifying a right to use an object through non-fungible token, NFT, comprising:
   a circuitry configured to:
      receive a public key presented by a user;
      access a cryptocurrency wallet set up for the object, wherein an NFT associated with the object is included in the cryptocurrency wallet;
      verify whether the user has a right to use the object based on the public key; and
      allow access to the object if the verification is successful, otherwise reject access to the object.
(14) The system of (13), wherein the circuitry is configured to:
   transfer the NFT associated with the object from a first cryptocurrency address to a second cryptocurrency address in the cryptocurrency wallet on a condition that a right to use the object is granted to a user, the second cryptocurrency being derived from the public key; and
   transfer the NFT from the second cryptocurrency address to the first cryptocurrency address in the cryptocurrency wallet on return of the object or expiration of the right to use the object.
(15) A machine-readable medium including code, when executed, to cause a machine to perform a method of any one of (1)-(9).

The aspects and features mentioned and described together with one or more of the previously detailed examples and figures, may as well be combined with one or more of the other examples in order to replace a like feature of the other example or in order to additionally introduce the feature to the other example.

Examples may further be or relate to a computer program having a program code for performing one or more of the above methods, when the computer program is executed on a computer or processor. Steps, operations or processes of various above-described methods may be performed by programmed computers or processors. Examples may also cover program storage devices such as digital data storage media, which are machine, processor or computer readable and encode machine-executable, processor-executable or computer-executable programs of instructions. The instructions perform or cause performing some or all of the acts of the above-described methods. The program storage devices may comprise or be, for instance, digital memories, magnetic storage media such as magnetic disks and magnetic tapes, hard drives, or optically readable digital data storage media. Further examples may also cover computers, processors or control units programmed to perform the acts of the above-described methods or (field) programmable logic arrays ((F)PLAs) or (field) programmable gate arrays ((F)PGAs), programmed to perform the acts of the above-described methods.

The description and drawings merely illustrate the principles of the disclosure. Furthermore, all examples recited herein are principally intended expressly to be only for pedagogical purposes to aid the reader in understanding the principles of the disclosure and the concepts contributed by the inventor(s) to furthering the art. All statements herein reciting principles, aspects, and examples of the disclosure, as well as specific examples thereof, are intended to encompass equivalents thereof.

A functional block denoted as “means for . . . ” performing a certain function may refer to a circuit that is configured to perform a certain function. Hence, a “means for s.th.” may be implemented as a “means configured to or suited for s.th.”, such as a device or a circuit configured to or suited for the respective task.

Functions of various elements shown in the figures, including any functional blocks labeled as “means”, “means for providing a sensor signal”, “means for generating a transmit signal.”, etc., may be implemented in the form of dedicated hardware, such as “a signal provider”, “a signal processing unit”, “a processor”, “a controller”, etc. as well as hardware capable of executing software in association with appropriate software. When provided by a processor, the functions may be provided by a single dedicated processor, by a single shared processor, or by a plurality of individual processors, some of which or all of which may be shared. However, the term “processor” or “controller” is by far not limited to hardware exclusively capable of executing software but may include digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

A block diagram may, for instance, illustrate a high-level circuit diagram implementing the principles of the disclosure. Similarly, a flow chart, a flow diagram, a state transition diagram, a pseudo code, and the like may represent various processes, operations or steps, which may, for instance, be substantially represented in computer readable medium and so executed by a computer or processor, whether or not such computer or processor is explicitly shown. Methods disclosed in the specification or in the claims may be implemented by a device having means for performing each of the respective acts of these methods.

It is to be understood that the disclosure of multiple acts, processes, operations, steps or functions disclosed in the specification or claims may not be construed as to be within the specific order, unless explicitly or implicitly stated otherwise, for instance for technical reasons. Therefore, the disclosure of multiple acts or functions will not limit these to a particular order unless such acts or functions are not interchangeable for technical reasons. Furthermore, in some examples a single act, function, process, operation or step may include or may be broken into multiple sub-acts,-functions,-processes,-operations or -steps, respectively. Such sub acts may be included and part of the disclosure of this single act unless explicitly excluded.

Furthermore, the following claims are hereby incorporated into the detailed description, where each claim may stand on its own as a separate example. While each claim may stand on its own as a separate example, it is to be noted that-although a dependent claim may refer in the claims to a specific combination with one or more other claims-other examples may also include a combination of the dependent claim with the subject matter of each other dependent or independent claim. Such combinations are explicitly proposed herein unless it is stated that a specific combination is not intended. Furthermore, it is intended to include also features of a claim to any other independent claim even if this claim is not directly made dependent to the independent claim.

1. A method for granting a right to use an object through non-fungible token, NFT, comprising:
transferring an NFT associated with the object from a first cryptocurrency address to a second cryptocurrency address in a cryptocurrency wallet set up for the object; and
transferring a public key associated with the second cryptocurrency address to a user to whom the right to use the object is granted,
wherein the right to use the object can be verified based on the public key associated with the second cryptocurrency address.

2. The method of claim 1, further comprising:
transferring the NFT from the second cryptocurrency address to the first cryptocurrency address in the cryptocurrency wallet on return of the object or expiration of the right to use the object.

3. The method of claim 1, further comprising:
receiving a payment from the user on the second cryptocurrency address.

4. The method of claim 1, wherein each cryptocurrency address in the cryptocurrency wallet is associated with a pair of private and public keys, the object is associated to a specific root seed, and private keys associated with the object are generated by a hierarchical deterministic tree (HDT) using the root seed.

5. The method of claim 1, wherein the object includes the cryptocurrency wallet and a software module running on a system in the object verifies the right to use the object by checking whether the second cryptocurrency address in the cryptocurrency wallet includes the NFT.

6. The method of claim 1, wherein the public key is used as an access code to unlock the object.

7. The method of claim 1, wherein the object is a rental vehicle or a shared vehicle shared among a plurality of users.

8. A method for verifying a right to use an object through non-fungible token, NFT, comprising:
receiving a public key presented by a user;
accessing a cryptocurrency wallet set up for the object, wherein an NFT associated with the object is included in the cryptocurrency wallet;
verifying whether the user has a right to use the object based on the public key; and
allowing access to the object if the verification is successful, otherwise rejecting access to the object.

9. The method of claim 8, further comprising:
transferring the NFT associated with the object from a first cryptocurrency address to a second cryptocurrency address in the cryptocurrency wallet on a condition that a right to use the object is granted to a user, the second cryptocurrency being derived from the public key; and
transferring the NFT from the second cryptocurrency address to the first cryptocurrency address in the cryptocurrency wallet on return of the object or expiration of the right to use the object.

10. A system for granting a right to use an object through non-fungible token, NFT, comprising:
a circuitry configured to transfer an NFT associated with the object from a first cryptocurrency address to a second cryptocurrency address in a cryptocurrency wallet set up for the object on a condition that a right to use the object is granted to a user; and
a circuitry configured to transfer a public key associated with the second cryptocurrency address to the user,
wherein the right to use the object can be verified based on the public key associated with the second cryptocurrency address.

11. The system of claim 10, wherein the circuitry is configured to transfer the NFT from the second cryptocurrency address to the first cryptocurrency address in the cryptocurrency wallet on return of the object or expiration of the right to use the object.

12. The system of claim 10, further comprising a circuitry configured to receive a payment from the user on the second cryptocurrency address.

13. A system for verifying a right to use an object through non-fungible token, NFT, comprising:
a circuitry configured to:
receive a public key presented by a user;
access a cryptocurrency wallet set up for the object, wherein an NFT associated with the object is included in the cryptocurrency wallet;
verify whether the user has a right to use the object based on the public key; and
allow access to the object if the verification is successful, otherwise reject access to the object.

14. The system of claim 13, wherein the circuitry is configured to:
transfer the NFT associated with the object from a first cryptocurrency address to a second cryptocurrency address in the cryptocurrency wallet on a condition that a right to use the object is granted to a user, the second cryptocurrency being derived from the public key; and
transfer the NFT from the second cryptocurrency address to the first cryptocurrency address in the cryptocurrency wallet on return of the object or expiration of the right to use the object.

15. A machine-readable medium including code, when executed, to cause a machine to perform a method of claim 1.
